(19) United States
(12) Patent Application Publication
(10) Pub. No.: US 2026/0225163 A1
(43) Pub. Date: Aug. 6, 2026

(54) SHANK MEMBER FOR EXCHANGEABLE-HEAD CUTTING TOOL, AND CUTTING TOOL

(71) Applicant: TUNGALOY CORPORATION, Fukushima (JP)

(72) Inventors: Yuma KONDOU, Iwaki-shi (JP); Jun OTSUKA, Iwaki-shi (JP)

(73) Assignee: TUNGALOY CORPORATION, Fukushima (JP)

(21) Appl. No.: 19/449,320

(22) Filed: Jan. 14, 2026

(30) Foreign Application Priority Data
Feb. 6, 2025 (JP) 2025-018018

(51) Int. Cl. B23B 31/00; B23B 29/26

(52) U.S. Cl. CPC B23B 31/005; B23B 29/26; B23B 2231/0208; B23B 2231/0256

(57) ABSTRACT

By overcoming restrictions imposed by tool post specifications, the number and variety of rod-like cutting members that can be set in the tool post are increased, enabling efficient execution of various types of machining processes on a workpiece and thereby improving productivity. A shank member for an exchangeable-head cutting tool is formed in an elongated shape and has a head mounted on either end thereof.

### BACKGROUND

### Field

The present disclosure relates to a shank member for an exchangeable-head cutting tool, and a cutting tool having this shank member.

### Description of Related Art

In an automatic lathe that performs various types of machining processes such as drilling, internal grooving, and turning on a rotating workpiece (machining target), cutting tools having a rod-like cutting member, for example, secured to a holder are widely used. These cutting tools are mounted on a tool post, such as a rear tool post, B-axis tool post, or opposed tool post. These tool posts are typically designed to allow a large number of cutting tools to be mounted so that complex and various machining processes can be performed. However, cost limitations often restrict the type and number of tool posts, and there are also limitations on the type and number of tools that can be mounted on the tool post. As a solution to this problem, for example, Patent Publication JP-A-2007-62006 proposes a configuration that allows two rod-like cutting members to be attached to a single holder. This provides a cutting tool capable of multiple types of machining processes without increasing the number of tools mounted on the tool post.

### SUMMARY

The cutting tool disclosed in Patent Publication JP-A-2007-62006 still has the problem that it can be used only on a limited variety of tool posts. More specifically, in a conceivable configuration shown in FIG. 6A and FIG. 6B, a cutting tool 8A having one rod-like cutting member 81 secured to one end of a holder 82A is inserted into a mounting hole 91 of a tool post 9. To increase the number of cutting members 81, for example, a head 82B having two cutting members 81 can be attached to either end of the holder 82A as shown in FIG. 7. However, such a cutting tool 8B may not fit the mounting hole 91 of the tool post 9 because the head interferes with the mounting hole 91.

Accordingly, the present disclosure was made in view of the circumstances described above, with an object to provide a shank member that overcomes restrictions imposed by tool post specifications so that the number and variety of the cutting members that can be set in a tool post are increased, enabling efficient execution of various types of machining processes on a workpiece, and a cutting tool that includes this shank member.
[1] A shank member according to an example of the present disclosure is designed for an exchangeable-head cutting tool and formed in an elongated shape and has the head mounted on either end thereof.

In this configuration, the head is removably mounted on the shank member. The head can be mounted on the shank member that is already set in a tool post, and a plurality of cutting members can then be attached to this head. Alternatively, the head already carrying a plurality of cutting members may be mounted on the shank member. Therefore, unlike the conventional cutting tool 8B (see FIG. 7), a cutting tool with a larger head carrying an increased number of cutting members can be set in the tool post 9 without interfering with the mounting hole 91 of the tool post 9. Restrictions imposed by the tool post specification are thus overcome, allowing an increase in the type and number of the cutting members that can be set in the tool post, and enabling tool exchange regardless of tool post type. This also enables various types of machining processes to be performed efficiently on a workpiece.
[2] More specifically, the shank member may include a mounting part having a flat contact surface making contact with a part of the head. The head can be held on the shank member by pressing a part of the head (e.g., a projected part for the mounting purpose) against the flat contact surface of the mounting part of the shank member when secured thereto, so that the cutting tool is made compact.
[3] The mounting part may include a recessed part for the part of the head to fit in. With the part of the head (e.g., a projected part for the mounting purpose) fitting in the recessed part, the shank member can hold the head firmly when they are secured together.
[4] The shank member may include a screw hole that extends laterally through to the recessed part and receives a screw for securing the head to the shank member. This allows the screw for securing the head to be accommodated in the shank member, so that the shank member can be made even smaller. This configuration also allows the screw to be located at a readily visible position, so that the operation of fastening the head to the shank member with the screw can be carried out reliably and easily.
[5] More specifically, the screw hole may be formed at either end of a side wall. This allows the head and the shank member to be secured together reliably at the position close to the joint between them.
[6] In the configuration described above, the recessed part may have its central axis extending substantially parallel to the direction in which the head is fixed to the shank member. The recessed part thus configured enables a further reduction in the size of the shank member, reliably preventing interference between the head and the workpiece or adjacent cutting tools in the tool post.
[7] A cutting tool according to an example of the present disclosure is an exchangeable-head cutting tool including a head, and a shank member formed in an elongated shape and having the head mounted on either end thereof.
[8] In the configuration described above, the head may include a mounting part and a plurality of mounting holes configured to receive a substantially rod-like cutting member.

According to the present disclosure, restrictions imposed by the tool post specification are overcome, so that the number and variety of cutting members that can be set in the tool post are increased. This enables various types of machining processes to be performed efficiently on a workpiece, thereby improving productivity.

### BRIEF DESCRIPTION OF DRAWINGS

FIG. 1A is a perspective view illustrating a cutting tool 1 according to a first embodiment, and FIG. 1B is an exploded perspective view illustrating a part of the cutting tool 1;

FIG. 2A and FIG. 2B are a right side view and a bottom view, respectively, illustrating the cutting tool 1;

FIG. 3A to FIG. 3E are a right side view, a top view, a bottom view, a front view, and a rear view, respectively, illustrating a shank member 10 that forms part of the cutting tool 1;

FIG. 4A to FIG. 4E are a right side view, a top view, a bottom view, a front view, and a rear view, respectively, illustrating a head 20 and a cutting member 30 that form part of the cutting tool 1;

FIG. 5 is a schematic diagram showing a side view of the cutting tool 1 set in a tool post;

FIG. 6A and FIG. 6B are schematic diagrams showing a side view of a conventional cutting tool 8A before and after it is mounted on a tool post, respectively; and

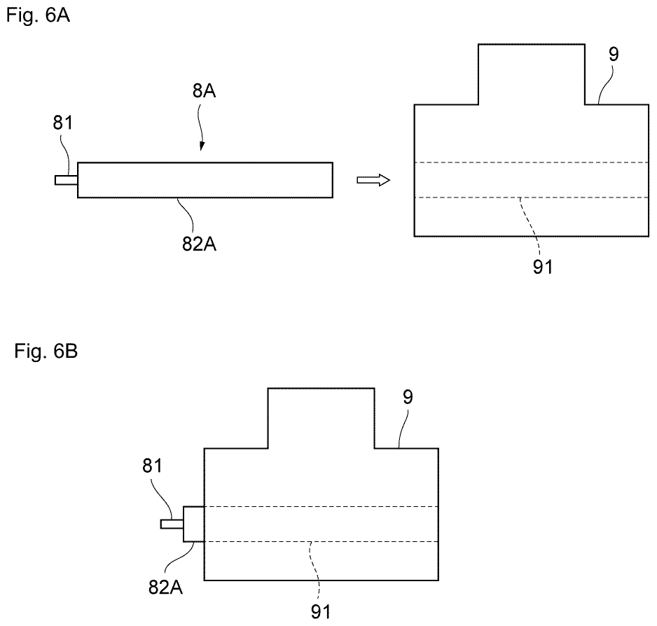

FIG. 7 is a schematic diagram showing a side view of a conventional cutting tool 8B before it is mounted on a tool post.

### DETAILED DESCRIPTION

Embodiments of the present invention are described below with reference to the accompanying drawings. For easier understanding of the description, the same constituent elements in the drawings are given the same reference numerals as much as possible and duplicate descriptions thereof will be omitted. The following embodiments of the present disclosure are described for illustrative purposes only, and should not be construed as limiting. Various modifications are possible within the scope of the present disclosure. A person skilled in the art can adopt an embodiment in which various elements described below are replaced with equivalents. These embodiments should also be included in the scope of the present disclosure.

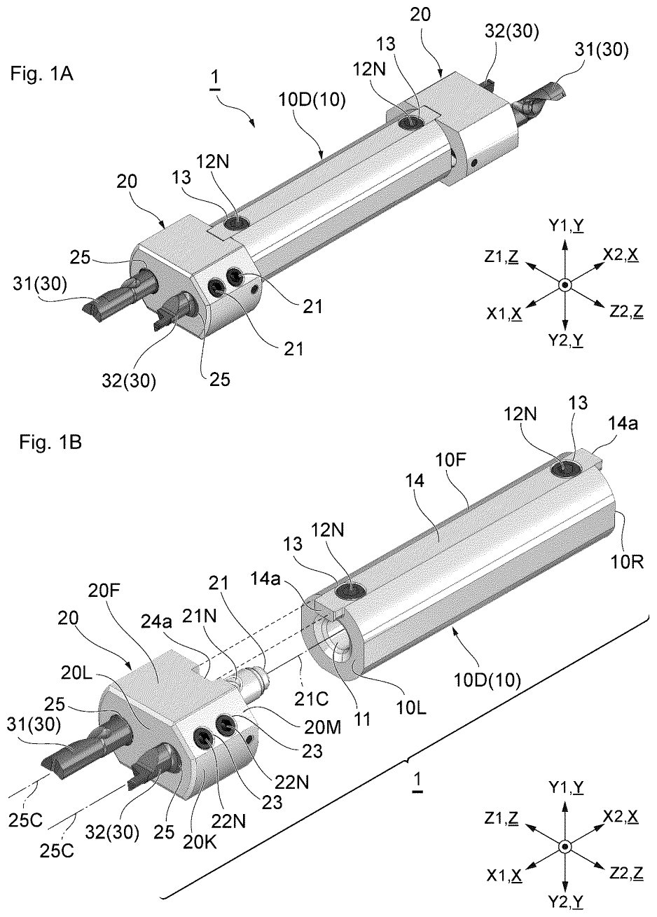

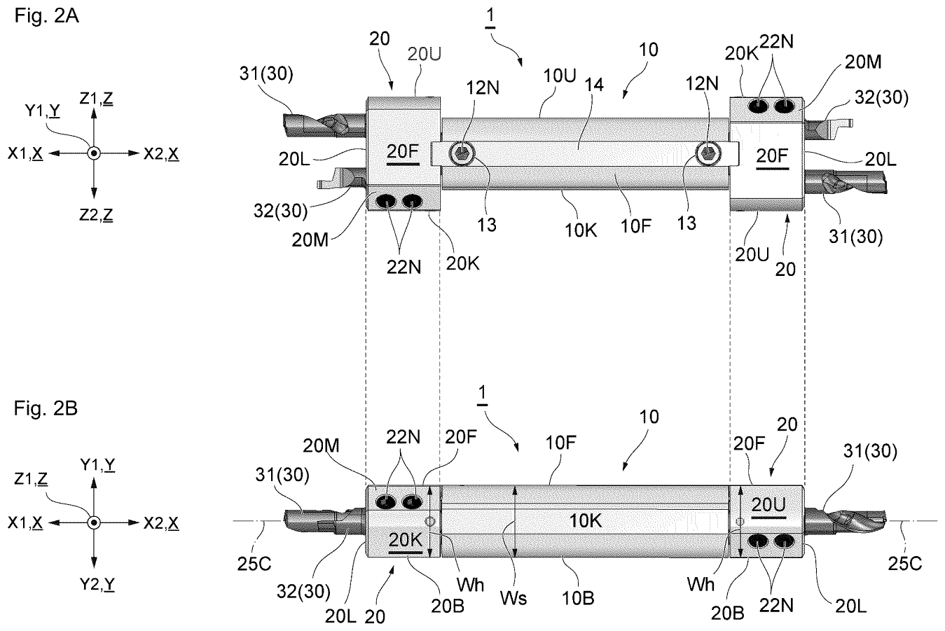

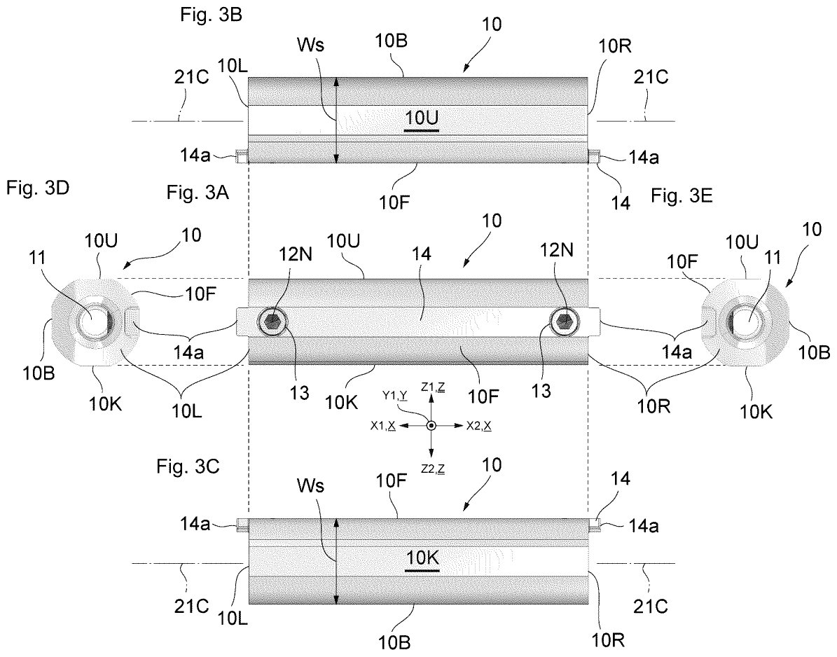

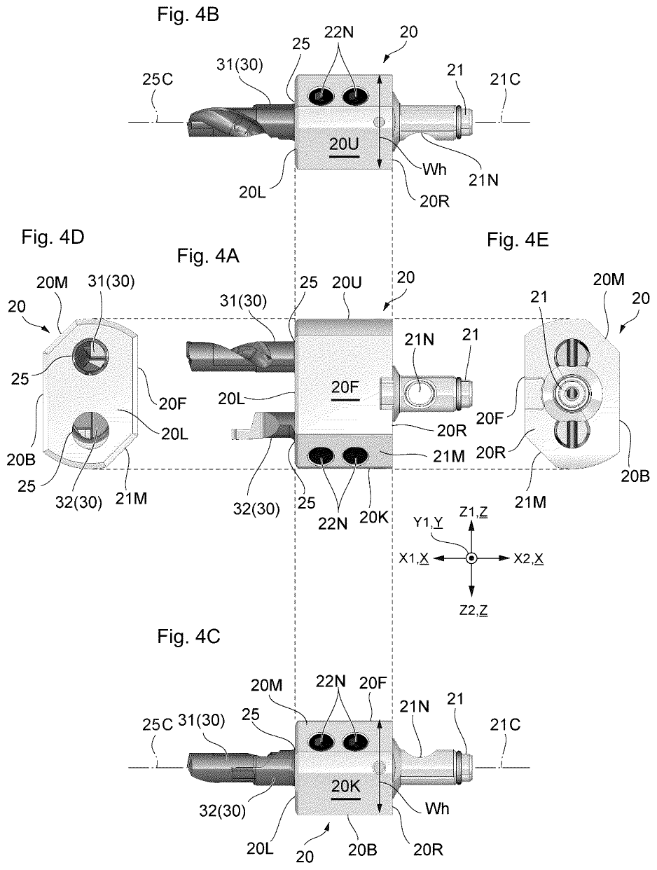

FIG. 1A is a perspective view illustrating a cutting tool 1 according to a first embodiment, and FIG. 1B is an exploded perspective view illustrating a part of the cutting tool 1. FIG. 2A and FIG. 2B are a right side view and a bottom view, respectively, illustrating the cutting tool 1. FIG. 3A to FIG. 3E are a right side view, a top view, a bottom view, a front view, and a rear view illustrating a shank member 10 that forms part of the cutting tool 1. FIG. 4A to FIG. 4E are a right side view, a top view, a bottom view, a front view, and a rear view illustrating a head 20 and a cutting member 30 that form part of the cutting tool 1. The coordinate axes shown in FIG. 3A to FIG. 3E and FIG. 4A to FIG. 4E apply to FIG. 3A and FIG. 4A, respectively.

In the present disclosure, the drawing sheet plane is used as a reference for convenience in explaining relative directions. Referring to the coordinate axes in FIG. 2A, FIG. 3A, FIG. 4A and others, the direction to the left may be referred to as “front X1,” and the opposite direction as “rear X2.” These directions may be collectively referred to as “front and back direction X.” In these drawings, the direction out of the plane of the drawing toward the viewer may be referred to as “right Y1,” and the opposite direction as “left Y2.” These directions may be collectively referred to as “left and right direction Y.” The upward direction may be referred to as “up (upper) Z1,” and the opposite direction as “down (lower) Z2.” These directions may be collectively referred to as “up and down direction Z.” In addition, a front view of a cutting tool 1 set in a tool post is seen from the front X1 to the rear X2, and a rear view is seen from the opposite direction. A right side view of the cutting tool 1 is seen from the right Y1 to the left Y2, and a left side view is seen from the opposite direction. A top view of the cutting tool 1 is seen from above (upper side Z1 to lower side Z2), and a bottom view is seen from the opposite direction.

As illustrated in these drawings, the cutting tool 1 according to this embodiment includes a shank member 10, two heads 20, and four cutting members 30. The shank member 10 includes a body part 10D extending linearly (in front and back direction X), and recessed parts 11 formed respectively on the front and rear surfaces (end surfaces) 10L and 10R of the body part for a projected part 21 of the head 20 to fit in (an example of “a part of the head” in the present disclosure). The body part 10D serves as the shank of the shank member 10 (shaft portion of the component). The shank member 10 has screw holes 13 at both ends of its right side surface 10F, in which screws 12N are inserted to secure the heads 20. In other words, the screw holes 13, which the screws 12N engage to secure the heads 20 to the shank member 10, are formed to extend laterally through to the recessed parts 11 at both ends of a side wall 14 of the body part 10D. Further, keys 14a for the positioning of the heads 20 protrude out from the front surface 10L and rear surface 10R of the body part 10D.

The head 20 includes a projected part 21 that fits in the recessed part 11 on one of the front and rear surfaces 10L and 10R of the shank member 10. The head 20 is mounted on the shank member 10, with these recessed part 11 and projected part 21 fitted to each other, and with the rear surface 20R (flat contact surface) around the projected part 21 and the front surface 10L (flat contact surface) around the recessed part 11 making contact with each other. The recessed part 11 of the shank member 10 is an example of a part of “a mounting part” in the present disclosure. The recessed part 11 and the flat contact surface of the front surface 10L are an example of the “mounting part” of the shank member in the present disclosure. The body of the projected part 21 is formed with an internal thread portion 21N for the screw 12N of the shank member 10 to engage. The head 20 is substantially in the form of a cuboid except for the projected part 21, having a thickness Wh (width in the left and right direction Y of the drawing) equal to the thickness Ws (width) of the shank member 10. The head 20 is further provided with a key groove 24a for the key 14a to fit in, at the boundary between the right side surface 20F and the rear surface 20R. The engagement between the key 14a and the key groove 24a enables the head 20 to be positioned relative to the shank member 10, so that the head 20 can be mounted easily and reliably on either end of the shank member 10.

The head 20 includes two mounting holes 25 in its front surface 20L for receiving rod-like tools 31 and 32 that are part of the cutting member 30 (an example of “a substantially rod-like cutting member” in the present disclosure). These mounting holes 25 have their central axes 25C located within the thickness (width) Ws of the shank member 10 (FIG. 2B). The central axes 25C extend substantially parallel to the direction 21C in which the head 20 is fixed to the shank member 10 (front and back direction X) as shown in FIG. 1B. The one-dot chain line indicating the fixing direction 21C in the drawing matches the central axis of the recessed part 11 (FIG. 1A). Therefore, the recessed part 11 also has its central axis substantially parallel to the direction in which the head 20 is fixed to the shank member 10. The fixing direction 21C and the central axes 25C are not shown in FIG. 3A and FIG. 4A due to space restrictions.

Further, the head 20 includes a screw engagement length adjustment surface 20M between the right side surface 20F and the lower surface 20K and between the left side surface 20B and the upper surface 20U, which is a flat surface connecting these surfaces. The screw engagement length adjustment surface 20M is a flat surface substantially parallel to the head parts of the screws 22N. Each screw engagement length adjustment surface 20M has two screw holes 23 aligned along the axial direction of the mounting holes 25, in which the screws 22N are inserted to secure each of the rod-like tools 31 and 32 to the head 20. In other words, the screw holes 23, which the screws 22N engage to secure the rod-like tools 31 and 32 to the head 20, are formed to extend laterally through to each mounting hole 25 at a predetermined angle relative to the XZ plane.

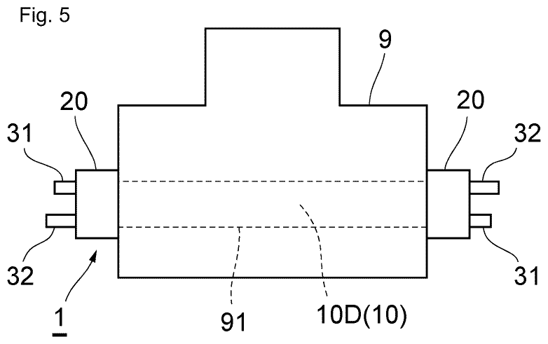

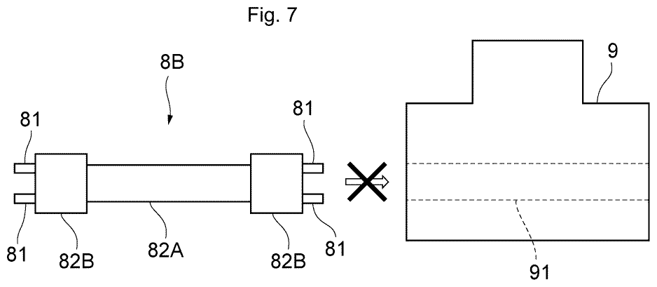

The exchangeable-head cutting tool 1 according to the first embodiment of the present disclosure is configured as described above such that the head 20 is removably mounted on the shank member 10. As illustrated in the schematic diagram of FIG. 5, the head 20 may be mounted on the shank member 10 that is already set in the tool post 9. The cutting member 30 may then be attached to this head 20. Alternatively, the head 20 already carrying the cutting member 30 may be mounted on the shank member 10. Therefore, unlike the conventional cutting tool 8B (see FIG. 7), a cutting tool 1 with a larger head 20 carrying an increased number of rod-like cutting members can be set in the tool post 9 without interfering with the mounting hole 91 of the tool post 9. Restrictions imposed by the tool post specification are thus overcome, allowing an increase in the type and number of the rod-like cutting members that can be set in the tool post, and enabling tool exchange regardless of tool post type. This enables various types of machining processes to be performed efficiently on a workpiece, thereby improving productivity.

The head 20 has a projected part 21 that fits in the recessed part 11 of the shank member 10. The head 20 is mounted on the shank member 10, with these recessed part 11 and projected part 21 fitted to each other, and with the rear surface 20R (flat contact surface) around the projected part 21 and the front surface 10L (flat contact surface) around the recessed part 11 making contact with each other. Since the head 20 is pressed against the flat contact surface of the shank member 10 when secured thereto, the cutting tool 1 is made compact and takes up a reduced installation space in the tool post.

Since the projected part 21 is inserted in the recessed part 11 when the head 20 and the shank member 10 are fastened together with the screws 12N, the shank member 10 can firmly hold the head 20.

Moreover, the screw hole 13, which the screw 12N engages to secure the head 20 to the shank member 10, is formed to extend laterally through to the recessed part 11. This allows the screw 12N for securing the head 20 to be accommodated in the shank member 10, so that the shank member 10 can be made even smaller. This configuration also allows the screw 12N and screw hole 13 to be located at a readily visible position, so that the operation of fastening the head 20 to the shank member 10 with the screw can be carried out reliably and easily.

The screw holes 13, in which the screws 12N are inserted to secure the heads 20, are formed in the right side surface 10F of the shank member 10 at both ends thereof. This offers the advantage that the head 20 and the shank member 10 can be secured reliably at the position close to the joint between them.

The recessed part 11 of the shank member 10 having its central axis extending substantially parallel to the direction 21C (front and back direction X) in which the head 20 is fixed to the shank member 10 (FIG. 1B) enables a further size reduction of the shank member 10. This reliably prevents interference between the head 20 and the workpiece or adjacent cutting tools set in the tool post, enabling a further increase in the installation density of cutting tools on the tool post, and thereby enhancing productivity.

Since the head 20 is substantially cuboidal except for the projected part 21 (mounting part), the overall shape of the head 20 can be formed to have a thin profile with a predetermined aspect ratio, as in this embodiment. Accordingly, the thickness Wh (width) of the head can be made equal to or less than the thickness Ws (width) of the shank member. This allows the head to be made small and lightweight, and when the cutting tool with a head mounted on the component set in the tool post, the cutting tool readily avoids interference with another adjacent cutting tools. This allows the installation density of cutting tools on the tool post to be increased, thereby enhancing productivity. The shank member 10 and the head 20 having the same thickness are flush with each other and facilitate a reduction in the overall thickness of the cutting tool 1. This allows the cutting tool 1 to avoid interference with adjacent cutting tools more easily when set in the tool post.

The mounting holes 25 having their central axes 25C located within the thickness Ws of the shank member 10 (FIG. 2B) also help reduce the size of the head 20. By avoiding interference between the head 20 and the workpiece or adjacent cutting tools set in the tool post, the installation density of cutting tools on the tool post can be increased, whereby productivity is enhanced. Since the shank member 10 provides support for the cutting edges of the rod-like tools 31 and 32 that are subjected to the cutting forces during machining, the overall rigidity of the cutting tool 1 is enhanced.

The mounting holes 25 having their central axes 25C extending substantially parallel to the direction 21C (front and back direction X) in which the head 20 is fixed to the shank member 10 (FIG. 1B) enable a further size reduction of the head 20. This reliably prevents interference between the head 20 and the workpiece or adjacent cutting tools set in the tool post, enabling a further increase in the installation density of cutting tools on the tool post, and thereby enhancing productivity.

Moreover, the screw holes 23, which the screws 22N engage to secure the rod-like tools 31 and 32 to the head 20, are formed to extend laterally through to the mounting holes 25 at a predetermined angle relative to the XZ plane. This allows the screws 22N for securing the rod-like tools 31 and 32 to be accommodated in the head 20, so that the head 20 can be made even smaller. This configuration also allows the screws 22N and screw holes 23 to be located at readily visible positions, so that the operation of fastening the rod-like tools 31 and 32 to the head 20 with the screws can be carried out reliably and easily.

Further, the head 20 includes a screw engagement length adjustment surface 20M, which is a flat surface substantially parallel to the head parts of the screws 22N, between the right side surface 20F and the lower surface 20K and between the left side surface 20B and the upper surface 20U, and the screw holes 23 are formed in this screw engagement length adjustment surface 20M. This improves the ease of operating the screws 22N, and allows the diagonal formation of the screw holes 23 extending laterally toward the mounting holes 25. Therefore, while ensuring an effective engagement length of the screws 22N for securing the rod-like tools 31 and 32 to the head 20, the operation of fastening the screws 22N is facilitated. The structure also helps reduce the volume of the head 20, enabling a further reduction in the weight of the head 20 and the cutting tool 1.

The embodiments have been described above for facilitating the understanding of the present disclosure and not for limiting the interpretation of the present disclosure. Namely, the present disclosure is not necessarily limited to the specific configurations described above. As long as the features of the present disclosure are entailed, any variations with design changes made to these specific configurations as appropriate by those skilled in the art are also included in the scope of the present disclosure. Unless otherwise explicitly specified, various elements, arrangements, materials, conditions, shapes, sizes and scales of the specific configurations described above are not particularly limited to the illustrated examples and may be changed as required. Further, the elements in the specific configurations described above may be variously combined as suited as long as there is no technical inconsistency.

The shank member 10 is basically cylindrical, having flat surface portions made by cutting away part of the cylindrical surface. In the embodiment described above, the right side surface 10F, left side surface 10B, upper surface 10U, and lower surface 10K correspond to the flat surface portions. The flat surface portion may be provided only on the surface where the screws 12N are provided. The screws 12N, 22N, and 42N need not be countersunk screws. The shank member 10 may not necessarily include the key 14a and key groove 24a. The head 20 may be fastened to the shank member 10 only by fitting the projected part 21 of the head 20 in the recessed part 11 of the shank member 10.

The shank member 10 according to the present disclosure, as described above and shown in FIGS. 1 to 3, has a head mounted on both ends thereof and includes a mounting part having a contact flat surface that abuts a part of the head. The contact flat surface is the entire surface of the end face (flat front surface 10L and rear surface 10R) of the shank member 10, and does not have a cutout-shaped concave structure for fitting the head 20, nor a convex structure for fitting into the head 20. Furthermore, a peripheral surface of a body portion 10D of the shank member 10 includes flat surfaces such as an upper surface 10U, a lower surface 10K, and a left side surface 10B, and a curved right side surface 10F. The peripheral surface of the body portion 10D is rotationally symmetric by 90° or 180° in a cross section or a side surface perpendicular to an extending axial direction of the shank member 10. In particular, as shown in FIG. 3, the recessed part 11 can be provided as a through-hole penetrating the shank member 10 in the extending axial direction.

Focusing on the relationship with the head, the head has a configuration in which a plurality of mounting holes configured to receive a substantially rod-like cutting member are formed on the same end surface. That is, by mounting a head having such a configuration on both ends of the shank member according to the present disclosure, it is possible to overcome restrictions imposed by the specifications of the tool post, in view of the problems associated with the cutting tool to which the head is attached. As a result, the type and number of rod-like cutting members that can be set in the tool post can be increased, which has the advantage of efficiently executing multiple types of machining processes on a workpiece.

What is claimed is:

1. A shank member for an exchangeable-head cutting tool,
having an elongated shape and a head mounted on either end thereof.

2. The shank member according to claim 1, further including a mounting part having a flat contact surface making contact with a part of the head.

3. The shank member according to claim 2, wherein the mounting part includes a recessed part in which the part of the head is inserted.

4. The shank member according to claim 3, wherein the shank member includes a screw hole that a screw engages to secure the head to the shank member, the screw hole extending laterally through to the recessed part.

5. The shank member according to claim 4, wherein the screw hole is provided at either end of a side wall of the shank member.

6. The shank member according to claim 3, wherein the recessed part has a central axis substantially parallel to a direction in which the head is fixed to the shank member.

7. An exchangeable-head cutting tool comprising:
a head; and
a shank member formed in an elongated shape and having the head mounted on either end thereof.

8. The cutting tool according to claim 7, wherein the head includes a mounting part; and a plurality of mounting holes configured to receive a substantially rod-like cutting member.

9. The shank member according to claim 2, wherein the contact flat surface is a flat surface formed on an end face of the shank member, comprising a region excluding a cutout-shaped recessed part for fitting another member, and having no convex part for fitting into the other member.

10. The shank member according to claim 1, wherein a peripheral surface of the body portion includes a flat surface part and a curved surface part.

11. The shank member according to claim 1, wherein the peripheral surface of the body portion is rotationally symmetric by 90° or 180° in a cross section or a side surface perpendicular to an extending axial direction of the shank member.

12. The shank member according to claim 3, wherein the recessed part is provided as a through-hole penetrating the shank member in an extending axial direction.
